(19) United States
(12) Patent Application Publication
(10) Pub. No.: US 2026/0156098 A1
(43) Pub. Date: Jun. 4, 2026

(54) METHODS AND SYSTEM FOR ACCESSING A PRIVATE NETWORK

(71) Applicant: CLOUD INTELLIGENCE ASSETS HOLDING (SINGAPORE) PRIVATE LIMITED, Singapore (SG)

(72) Inventors: Jinda LU, Hangzhou, Zhejiang (CN); Zhenzao Wen, Hangzhou, Zhejiang (CN); Zhiyuan HOU, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/123,425

(22) PCT Filed: Oct. 23, 2023
(86) PCT No.: PCT/CN2023/125990

§ 371 Date: Apr. 23, 2025

(30) Foreign Application Priority Data
Oct. 24, 2022 (CN) 202211303046.1

(51) Int. Cl. H04L 61/4511

(52) U.S. Cl. CPC H04L 61/4511

(57) ABSTRACT

One of methods comprises: obtaining a domain name resolution request from a client, wherein the client is an accessing end to access the private network; determining that the domain name resolution request conforms to a domain name format of the private network; allocating a virtual address corresponding to the domain name format to the private network; in response to a resource access request from the client, resolving a target domain name of the private network from the virtual address in response to a resource access request from the client, wherein the resource access request conforms to the domain name format, and the target domain name is used for representing a target address of the private network; and accessing a network resource in the private network based on an original domain name of the private network corresponding to the target domain name.

### CROSS REFERENCE TO RELATED APPLICATIONS

The present disclosure is a National Stage of International Application PCT/CN 2023/125990, filed on Oct. 23, 2023, which claims priority of Chinese Patent Application No. 202211303046.1, filed with the Chinese Patent Office on Oct. 24, 2022, entitled “PRIVATE NETWORK ACCESS METHODS AND SYSTEM”, the entire contents of the mentioned applications are incorporated herein by reference.

### TECHNICAL FIELD

The present disclosure relates to the field of cloud computing, in particular, to methods and system for accessing a private network.

### BACKGROUND

At present, for the problem of a client accessing a private network, it is usually to establish three-layer network connectivity between the client and a server so as to realize the access of the client to the private network.

However, a new routing rule needs to be added in the process of establishing connectivity of the three-layer network. The new routing rule will cause a network segment conflict with the existing network, thereby changing the basic network environment of the client, and the number of private networks that can be connected using the method is limited, because the number of private networks will increase with the increase of the clients. Therefore, the method has a technical problem of low network connectivity efficiency.

In view of the above problem, at present, there is no effective solution.

### SUMMARY

The examples of the present disclosure provide a private network method and system, so as to at least solve the technical problem of low network connectivity efficiency.

According to an aspect of an example of the present disclosure, a method for accessing a private network is provided. The method may include: obtaining a domain name resolution request from a client, where the client is an accessing end to access the private network; determining that the domain name resolution request conforms to a domain name format of the private network; allocating a virtual address corresponding to the domain name format to the private network; resolving a target domain name of the private network from the virtual address in response to a resource access request from the client, where the resource access request conforms to the domain name format, and the target domain name is used to characterize a target address of the private network; and accessing a network resource in the private network based on an original domain name of the private network corresponding to the target domain name, where the domain name format is used for encoding the original domain name into the target domain name, and the original domain name is used for characterizing an original address of the private network.

According to another aspect of the examples of the present disclosure, another method for accessing a private network is further provided. The method may include: obtaining an original domain name of the private network, where the original domain name is used for characterizing an original address of the private network; encoding the original domain name according to a domain name format of the private network to obtain a target domain name of the private network, where the target domain name is used for characterizing a target address of the private network; issuing the target domain name to a client, so that the client sends, based on the target domain name, a domain name resolution request conforming to the domain name format, and a resource access request conforming to the domain name format, where the domain name resolution request is used for allocating a virtual address corresponding to the domain name format to the private network; the resource access request is used for resolving the target domain name of the private network from the virtual address, and the original domain name corresponding to the target domain name is used for accessing a network resource in the private network.

According to another aspect of the examples of the present disclosure, another method for accessing a private network is further provided. The method may include: obtaining an original domain name of the private network by invoking a first interface, where the first interface includes a first parameter, a parameter value of the first parameter is the original domain name, and the original domain name is used for characterizing an original address of the private network; encoding the original domain name according to a domain name format of the private network to obtain a target domain name of the private network, where the target domain name is used for characterizing a target address of the private network; issuing the target domain name to a client by invoking a second interface, so that the client, based on the target domain name, sends a domain name resolution request conforming to the domain name format and a resource access request conforming to the domain name format, where the second interface includes a second parameter, a parameter value of the second parameter is the target domain name, the domain name resolution request is used for allocating a virtual address corresponding to the domain name format to the private network, the resource access request is used for resolving the target domain name of the private network from the virtual address, and the original domain name corresponding to the target domain name is used for accessing a network resource in the private network.

According to another aspect of the examples of the present disclosure, a system for accessing a private network is provided. The system may include a client configured to send a domain name resolution request to the network proxy container, where the client is an accessing end to access the gateway; a network proxy container, configured to determine that the domain name resolution request conforms to a domain name format of the gateway; allocate a virtual address corresponding to the domain name format to the gateway; resolve a target domain name of the gateway from the virtual address in response to a resource access request from the client, where the resource access request conforms to the domain name format, and the target domain name is used for characterizing a target address of the private network; access a network resource in the gateway based on an original domain name of the gateway corresponding to the target domain name, where the domain name format is used for encoding the original domain name into the target domain name, and the original domain name is used for characterizing an original address of the private network; and a gateway, configured to return the network resource to the network proxy container.

According to another aspect of the examples of the present disclosure, an apparatus for accessing a private network is provided. The apparatus may include: a first obtaining unit, configured to obtain a domain name resolution request from a client, where the client is an accessing end to access the private network; a determining unit, configured to determine that the domain name resolution request conforms to a domain name format of the private network; an allocation unit, configured to allocate a virtual address corresponding to the domain name format to the private network; a resolution unit, configured to, resolve a target domain name of the private network from the virtual address in response to a resource access request from the client, where the resource access request conforms to the domain name format, and the target domain name is used to characterize a target address of the private network; an access unit, configured to access a network resource in the private network based on an original domain name of the private network corresponding to the target domain name, where the domain name format is used for encoding the original domain name into the target domain name, and the original domain name is used for characterizing an original address of the private network.

According to another aspect of the examples of the present disclosure, another apparatus for accessing a private network is provided. The apparatus may include: a second obtaining unit, configured to obtain an original domain name of the private network, where the original domain name is used for characterizing an original address of the private network; a first processing unit, configured to encode the original domain name according to a domain name format of the private network to obtain a target domain name of the private network, where the target domain name is used for characterizing a target address of the private network; a first issuing unit, configured to issue the target domain name to a client, so that the client sends, based on the target domain name, a domain name resolution request conforming to the domain name format, and a resource access request conforming to the domain name format, where the domain name resolution request is used for allocating a virtual address corresponding to the domain name format to the private network; the resource access request is used for resolving the target domain name of the private network from the virtual address, and the original domain name corresponding to the target domain name is used for accessing a network resource in the private network.

According to another aspect of the examples of the present disclosure, another apparatus for accessing a private network is provided. The apparatus may include: a third obtaining unit, configured to obtain an original domain name of the private network by invoking a first interface, where the first interface includes a first parameter, a parameter value of the first parameter is the original domain name, and the original domain name is used for characterizing an original address of the private network; a second processing unit, configured to encode the original domain name according to a domain name format of the private network to obtain a target domain name of the private network, where the target domain name is used for characterizing a target address of the private network; a second issuing unit, configured to issue the target domain name to a client by invoking a second interface, so that the client, based on the target domain name, sends a domain name resolution request conforming to the domain name format and a resource access request conforming to the domain name format, where the second interface includes a second parameter, a parameter value of the second parameter is the target domain name, the domain name resolution request is used for allocating a virtual address corresponding to the domain name format to the private network, the resource access request is used for resolving the target domain name of the private network from the virtual address, and the original domain name corresponding to the target domain name is used for accessing a network resource in the private network.

According to another aspect of the examples of the present disclosure, a computer readable storage medium is provided. The computer readable storage medium stores a program, where when the program runs controlling a device where the storage medium is located to perform any one of the above methods for accessing a private network.

According to another aspect of the examples of the present disclosure, a processor is provided. The processor is configured to run a program, where when the processor runs the program, perform any one of the above methods for accessing a private network.

### BRIEF DESCRIPTION OF DRAWINGS

The accompanying drawings set forth herein are used to provide a further understanding of the present disclosure, and constitute a part of the present disclosure. The illustrative examples and descriptions thereof are for the purpose of illustrating the present disclosure and are not intended to unduly limit the present disclosure. The drawings are introduced in the following.

FIG. 1 is a structural block diagram illustrating a computing environment according to an example of the present disclosure.

FIG. 2 is a flowchart illustrating a method for accessing a private network according to an example of the present disclosure.

FIG. 3 is a flowchart illustrating another method for accessing a private network according to an example of the present disclosure.

FIG. 4 is a flowchart illustrating another method for accessing a private network according to an example of the present disclosure.

FIG. 5 is a schematic diagram illustrating a computer device accessing a private network according to an example of the present disclosure.

FIG. 6 is a schematic diagram illustrating a system for accessing a private network according to an example of the present disclosure.

FIG. 7 is a schematic diagram illustrating a port mapping process according to the related art.

FIG. 8 is a schematic diagram illustrating a system for establishing network connectivity to a private network according to an example of the present disclosure.

FIG. 9A is a flowchart illustrating a method for establishing network connectivity to a private network according to an example of the present disclosure.

FIG. 9B is a schematic diagram illustrating resolving an original network service according to an example of the present disclosure.

FIG. 10 is a structural block diagram illustrating a service mesh of a method for accessing a private network according to an example of the present disclosure.

FIG. 11 is a schematic diagram illustrating an apparatus for accessing a private network according to an example of the present disclosure.

FIG. 12 is a schematic diagram illustrating another apparatus for accessing a private network according to an example of the present disclosure.

FIG. 13 is a schematic diagram illustrating another apparatus for accessing a private network according to an example of the present disclosure.

FIG. 14 is a structural block diagram of a computer terminal according to an example of the present disclosure.

### DETAILED DESCRIPTION

In order to enable those in the art to better understand the solution of the present disclosure, the technical solutions in the examples of the present disclosure will be clearly and completely described in the following with reference to the accompanying drawings in the examples of the present disclosure. Obviously, the described examples are merely a part of the examples in the present disclosure, not all of them. Based on the examples in the present disclosure, all other examples obtained by those of ordinary skill in the art without creative work should fall within the scope of protection of the present disclosure.

It should be noted that the terms “first”, “second,” and the like in the description and claims and the accompanying drawings of the present disclosure are used to distinguish between similar objects and are not necessarily for describing a particular sequence or order. It should be understood that the data used herein may be interchanged under appropriate circumstances so that the examples of the present disclosure described herein may be implemented in an order other than those illustrated or described in the accompanying drawings and descriptions. Furthermore, the terms “comprising”, “including”, and any variations thereof, are intended to cover a non-exclusive inclusion, e.g., a process, method, system, product, or apparatus that includes a series of steps or elements is not necessarily limited to the explicitly listed steps or elements, but may include other steps or elements not expressly listed or inherent to such process, method, product, or apparatus.

First, some nouns or terms appearing in the description of the examples of the present disclosure are to be interpreted in the following.

An open source system (Kubernetes, abbreviated as K8S) may be an open source system for automatic deployment, expansion and management of containerized applications.

A network proxy container (Sidecar) may be used to provide additional functions for a main container without changing the main container. The network proxy container may be deployed in the same container group (Pod) with a service container (non-Sidecar container) and share a same lifecycle, provide auxiliary functions for the service container, and may be used to intercept network traffic of the service container, and complete the establishment of the network connectivity.

A gateway orchestration service, which may be used to provide a fully hosted service mesh platform, may be used to provide containers with the ability of accessing other networks, where the mesh can implement the gateway orchestration service through an open source system (Kubernetes).

A network service, which may be used to access a network, may be implemented by various gateways, for example, the network service may be implemented by a gateway of a virtual private cloud (VPC), which may be used to establish network connectivity to another VPC.

A domain name system (DNS) which may be a basic service of the Internet, may be used to map domain names and Internet Protocol (IP) addresses to each other.

### Example 1

According to examples of the present disclosure, an example of a method for accessing a private network is provided. It should be noted that the steps shown in the flowcharts of the accompanying drawings may be performed in, for example, a computer system with a set of computer-executable instructions. Although the logical order is shown in the flowcharts, in some cases, the steps shown or described may be performed in a different order than herein.

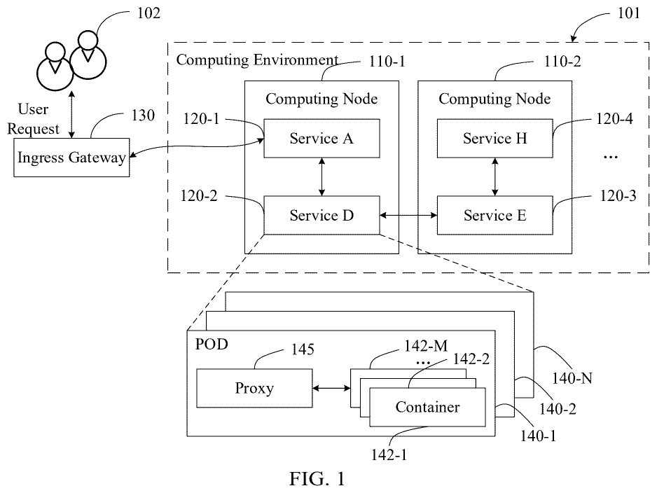

The method example provided in the Example 1 of the present disclosure may be performed in a mobile terminal, a computer terminal, or a similar computing apparatus. FIG. 1 shows, in a block diagram, an example where the computer terminals (or mobile devices) in FIG. 1 are used as computing nodes in a computing environment 101, which may be a cloud computing environment. FIG. 1 is a structural block diagram illustrating a cloud computing environment according to an example of the present disclosure. As shown in FIG. 1, the cloud computing environment may include computing nodes (such as servers) which deploy a plurality of services 120 (noted as 120-1, 120-2 . . . in the figure) running on a distributed network. Each computing node includes local processing resources and memory resources. An end user 102 may run applications or store data remotely in the cloud computing environment. The applications may be provided as the plurality of services 120-1, 120-2, 120-3, and 120-4 in the computing environment 101, representing services “A”, “D”, “E”, and “H”, respectively.

The end user 102 may provide and access services through a web browser or other software applications on the client. In some examples, provision and/or requests of the end user 102 may be provided to an ingress gateway 130. The ingress gateway 130 may include a corresponding proxy to handle provision and/or requests for each service 120 (one or more services provided in the computing environment 101).

The services 120 are provided or deployed in accordance with various virtualization technologies supported by the computing environment 101. In some examples, services 120 may be provided in accordance with virtual machine (VM)-based virtualization, container-based virtualization, and/or the like. Virtual machine-based virtualization may simulate a real computer by initializing a virtual machine to execute programs and applications without direct access to any actual hardware resources. While a virtual machine virtualizes a machine, according to container-based virtualization, a container can be launched to virtualize an entire operating system (OS) so that a plurality of workloads can run on a single operating system instance.

In an example based on container virtualization, several containers of a service 120 may be assembled into one POD (e.g., a Kubernetes POD). For example, as shown in FIG. 1, the service 120-2 may be equipped with one or more PODs 140-1, 140-2 . . . , 140-N (collectively called as POD 140). Each POD 140 may include an proxy 145 and one or more containers 142-1, 142-2, . . ., 142-M (collectively referred to as containers 142). The one or more containers 142 in the POD 140 process requests relate to one or more corresponding functions of the service, and the proxy 145 typically controls the network functions related to the service, such as routing, load balancing, and the like. Other services 120 may also be equipped with PODs similar to POD 140.

During operation, executing a user request from an end user 102 may require invoking one or more services 120 in the computing environment 101, and performing one or more functions of a service 120 may require invoking one or more functions of another service 120. As shown in FIG. 1, service “A” 120-1 receives a user request of an end user 102 from the ingress gateway 130, service “A” 120-1 may invoke service “D” 120-2, and service “D” 120-2 may request service “E” 120-3 to perform one or more functions.

The computing environment described above may be a cloud computing environment, where the allocation of resources is managed by a cloud service provider, allowing the development of functionality without considering implementing, adjusting, or expanding servers. This computing environment allows developers to execute code in response to events without building or maintaining complex infrastructure. Instead of extending individual hardware devices to handle potential loads, services can may be partitioned into a set of functions that can scale automatically and independently.

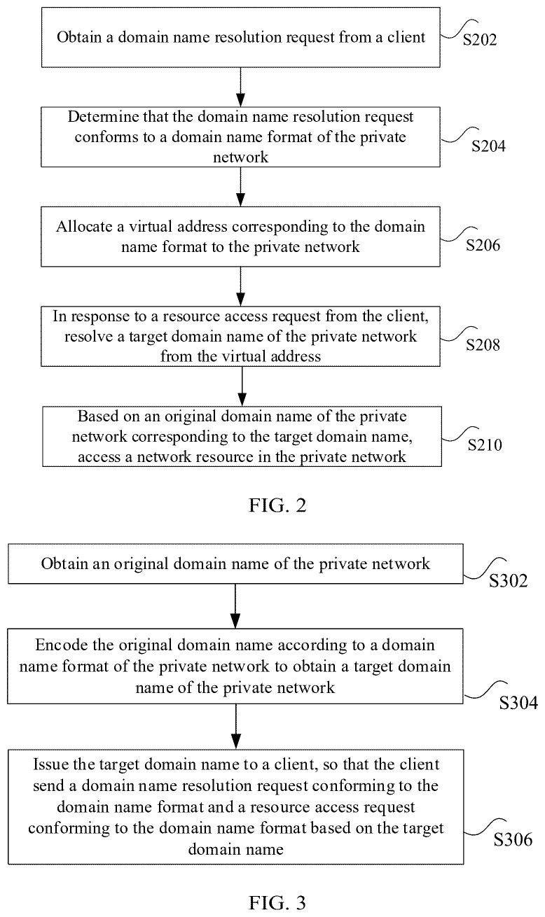

In an operating environment shown in FIG. 1, the present disclosure provides a private method for accessing a private network as shown in FIG. 2. It should be noted that the method for accessing the private network of this example may be performed by the mobile terminal of the example shown in FIG. 1.

FIG. 2 is a flowchart of a method for accessing a private network according to an example of the present disclosure. As shown in FIG. 2, the method may include the following steps.

In step S202, a domain name resolution request from a client is obtained, where the client is an accessing end to access a private network.

In the technical solution provided in the above step S202 of the present disclosure, a domain name resolution request from a client may be obtained, where the client may be an accessing end to access a private network, and may include a mobile device, a network client, etc., which is merely an example here, and is not specifically limited. The domain name resolution request may be a request to resolve a domain name, for example, may be a Hyper Text Transfer Protocol (HTTP)(s) request for an HTTP(s) resource or a request for a non-http (s) resource, which is merely an example, and the type of the request is not specifically limited. The private network may be a virtual private cloud (VPC).

For example, one can open a browser in a mobile device (computer), enter a domain name, and the client may send a domain name resolution request to a server so that the domain name resolution request of the client is obtained.

In step S204, it is determined that the domain name resolution request conforms to a domain name format of the private network.

In the technical solution provided in the above step S204 of the present disclosure, the obtained domain name resolution request may be resolved to determine whether the domain name resolution request conforms to the domain name format of the private network, where the domain name format may include a format of a host name, (for example, vpc 1.. . . ) , a format of a gateway orchestration service (e.g., http(s) format, non-http(s) format).

In an example, the domain name resolution request may be resolved by a domain name server (abbreviated as, DNS proxy), so as to determine a domain name format of the domain name resolution request, and determine whether the resolved domain name format conforms to the domain name format of the private network.

In step S206, a virtual address corresponding to the domain name format is allocated to the private network.

In the technical solution provided in the above step S206 of the present disclosure, if it is determined that the domain name resolution request conforms to the domain name format of the private network, a virtual address corresponding to the domain name format may be allocated to the private network, where the virtual address may be an allocated virtual Internet protocol address (Virtual IP, abbreviated as VIP).

For example, a domain name format of a domain name resolution request may be analyzed by a DNS proxy. If the domain name format of the domain name resolution request conforms to a domain name format of the private network (which may be a domain format of a gateway orchestration service), the DNS proxy may allocate a VIP to a transport proxy, where a network segment of the VIP may be selected to be a segment that does not conflict with network segments of a user cluster, for example, may be 21.0.0.0/8, and the network segment here is merely an example without specific limitations.

For example, an online database service (Relational Database Service, RDS) with a name vpc1 in the network services may be accessed, where an original address (domain name) of the online database service may be rds.a.com, and the address after encoding the name and additional parameters of the network service can be: ‘rds.a.com.vpc1. . . .’

In step S208, in response to a resource access request from the client, a target domain name of the private network is resolved from the virtual address, where the resource access request conforms to the domain name format, and the target domain name is used to characterize a target address of the private network.

In the technical solution provided in the above step S208 of the present disclosure, the resource access request from the client is obtained, and in response to the resource access request from the client, the target domain name of the private network may be resolved from the virtual address, where the resource access request may be a request initiated by an application to a VIP, and may be a request for accessing resources of other clients, and may be an http request, for example, may be ‘www.a.com.vpc1.http . . . ’. The target domain name may be an encoded domain name, and may be used to characterize the target address of the private network. For example, the target domain name may be an address of a new destination represented by a domain name. The new destination may be a destination or a server where the client needs to access the resources, which is not specifically limited here.

In an example, a resource access request may be initiated by an application in the client. In response to the resource access request initiated from the client, a target domain name for characterizing the target address of the private network may be resolved from the virtual address.

In an example, the application may access the encoded target domain name (new destination address) so that the network connectivity is realized. The domain name of the private network may be encoded into the original destination address to achieve the purpose of easily accessing the private network.

In step S210, based on the original domain name of the private network corresponding to the target domain name, the network resource in the private network is accessed, where the domain name format is used to encode the original domain name into the target domain name, and the original domain name is used for characterizing an original address of the private network.

In the technical solution provided in the above step S210 of the present disclosure, the target domain name of the private network may be resolved from the virtual address. The original domain name of the private network corresponding to the target domain name may be determined. The network resource in the private network may be accessed based on the original domain name, where the domain name format may be used to encode the original domain name into the target domain name. The original domain name may be used for characterizing the original address of the private network, and may be the original address before encoding. For example, the original domain name may be ‘rds.a.com’. The network resource may be a custom resource, for example, it may be a custom resource of network services, and this is merely an example without specific limitation.

In an example, the original domain name of the private network (network service) may be encoded. For example, a network tag (vpc1. . . .) may be appended to an original destination address of the network service. The newly added network tag may consist of a name of the network service (vpc1) and some additional parameters (for example, a name of the gateway orchestration service), so that it becomes a new destination address (target domain name) characterized by a domain name. Based on the target domain name, a resource in other networks can be accessed to reach a desired destination (a network resource in the private network).

As an example, to access a private network named vpc1 in the network services, the original domain name (original address) of the private network is ‘www.a.com’, the address obtained after encoding the original address and additional parameters (target domain name) is ‘www.a.com.vpc1.http. . . . ’ The network resource in the private network may be accessed based on the corresponding original domain name ‘www.a.com’in ‘www.a.com.vpc1.http. . . . .’

It should be noted that the above encoding related content is only an example, and no specific limitation is made here.

Through the steps S202 to S208 of the present disclosure, a domain name resolution request from a client is obtained, where the client is an accessing end to access a private network. It is determined that the domain name resolution request conforms to a domain name format of the private network. A virtual address corresponding to the domain name format is allocated to the private network. A target domain name of the private network is resolved from the virtual address in response to a resource access request from the client, where the resource access request conforms to the domain name format, and the target domain name is used for characterizing a target address of the private network. The network resource in the private network is accessed based on an original domain name of the private network corresponding to the target domain name, where the domain name format is used for encoding the original domain name into the target domain name, and the original domain name is used for characterizing an original address of the private network. That is to say, in the example of the present disclosure, it is determined that a domain name format conforming to the private network is determined based on the domain name resolution request from the client. Based on the domain name format of the private network, a virtual address corresponding to the domain name format is determined. A resource access request conforming to the domain name format sent by the client is obtained. A target domain name of the private network is resolved from the virtual address based on the resource access request. Based on an original domain name of the private network corresponding to the target domain name, the network resource in the private network may be accessed, so that the technical effect of improving the network connectivity efficiency is realized, and the technical problem of low network connectivity efficiency is solved.

The above method of this example is further described in the following.

In an example, a domain name field of an original domain name and a resource field of a network resource are determined. A domain name format is established based on the domain name field and the resource field.

In this example, an original domain name field and a resource field of a network resource may be determined. A domain name format may be established based on the domain name field and the resource field, where the domain name field may be used to characterize a service in network services, for example, may be used to characterize an online relational database service named vpc1 or an HTTP service named vpc1 in the network services. This is merely an example, and the domain name field is not specifically limited. The resource field may be used to characterize a location of the network resource, and may include a host name of the original destination, for example, it may be a custom field.

In an example, establishing the domain name format based on the domain name field and the resource field includes: extracting an attribute field of the network resource from the resource field, where the attribute field is used for representing the name and/or type of the network resource; and concatenating the attribute field to the end of the domain name field to obtain the domain name format.

In this example, the attribute field of the network resource may be extracted from the resource field, and the attribute field may be concatenated to the end of the domain name field to obtain a domain name format, where the resource field may include the attribute field. The attribute field may be used to indicate the name of the network resource (e.g., a field named vpc1) and/or the type of the network resource (e.g., http service).

For example, the domain name field of the original domain name may be a field of ‘rds.a.com’, the attribute field of the network resource may be a field of ‘vpc1’. The attribute field may be concatenated to the end of the domain name field to obtain a domain name format of ‘rds.a.com.vpc1. . . . .’

For another example, the domain name field of the original domain name may be a field of ‘www.a.com’, the attribute field of the network resource may be a field of ‘.vpc1.http’. The attribute field may be concatenated to the end of the domain name field to obtain a domain name format of ‘www.a.com.vpc1.http. . . . .’

In an example, it is detected whether the domain name resolution request includes an original domain name, and a name of a network resource and/or type of the network resource. If it is detected that the domain name resolution request includes the original domain name, and the name of the network resource and/or the type of the network resource, it is determined that the domain name resolution request conforms to a domain name format, where the name and/or type of network resource are located at the tail of the original domain name.

In this example, the original domain name may be detected in response to the domain name resolution request. It is determined whether the domain name resolution request includes the original domain name. The name of the network resource and/or the type of the network resource are determined. It is determined whether the detected domain name resolution request includes the original domain name and the name and/or type of the network resource. If the detected domain name resolution request includes the original domain name, and the name of the network resource and/or type of the network resource, it may be determined that the domain name resolution request conforms to the domain name format, where the name of the network resource and/or type of the network resource may be located at the tail of the original domain name.

For example, ‘https://www.taobao.com’ is opened on a browser. In response to a domain name resolution request, an original domain name of the domain name ‘www.taobao.com’ may be resolved by a domain name resolution server. If the domain name resolution request is detected to include the original domain name and the name and/or type of the network resource, it is determined that the domain name resolution request conforms to the domain name format.

In an example, the step S206 of allocating a virtual address corresponding to the domain name format to the private network includes: determining a first network segment where the client is currently located; determining a second network segment different from the first network segment; allocating a virtual address corresponding to the domain name format and located on the second network segment to the private network.

In this example, a first network segment where the client is currently located may be determined, and a virtual address corresponding to the domain name format and located on a second network segment may be allocated to the private network, where the second network segment and the first network segment are network segments at different locations, and the first network segment is different from the second network segment.

In an example, a DNS proxy may be used to allocate a virtual address corresponding to the domain name format to the private network, and the network segment of the virtual address may be selected to be a network segment that does not conflict with the network segment of the client (user cluster).

In the related art, the establishment of network connectivity of a three-layer network will change the basic network environment in an application. For example, a new routing rule needs to be added, but the new routing rule will cause a network segment conflict with the existing network. However, in the example of the present disclosure, a first network segment where the client is currently located is determined, and a virtual address of a second network segment, which corresponds to the domain name format and is different from the first network segment, is allocated to the private network, so that the network segment conflict with the existing network is avoided, the technical effect of improving the network connectivity efficiency is realized, and the technical problem of low network connectivity efficiency is solved.

In an example, in response to a resource access request being transmitted according to the hypertext transfer protocol, the resource access request is sanitized, where the sanitized resource access request conforms to an original domain name format of a private network. Based on the sanitized resource access request, an original domain name corresponding to a target domain name is resolved from a virtual address.

In this example, it may be determined whether the resource access request is transmitted according to the hypertext transfer protocol. If the resource access request is transmitted according to the hypertext transfer protocol, the resource access request may be sanitized to obtain an original domain name format conforming to the private network, and based on the sanitized resource access request, the original domain name corresponding to the target domain name may be resolved from the virtual address, where the original domain name format may be the domain name of the original address before encoding; and the resource access request may include a format of a gateway orchestration service in a server name indication (SNI).

In an example, if the resource access request is transmitted according to the hypertext transfer protocol, in response to the resource access request being transmitted as a hypertext transfer protocol request (e.g., www.a.com.vpc1.http. . . . ), the resource access request may be sanitized by using a communication bus (envoy). For example, the format of the gateway orchestration service in an https request may be removed. The sanitized resource access request conforms to a format of an original domain name of the private network (the original address before encoding), and the original domain name corresponding to the target domain name may be resolved from the virtual address based on the sanitized resource access request.

In an example of the present disclosure, the resource access request is sanitized, so that problems in a virtual host matching process can be avoided, and a coding part in TLS SNI can be removed to avoid a TLS handshake failure, thereby improving the efficiency of network connectivity.

In an example, an allocated VIP may be resolved by a transport proxy to obtain an encoded domain name, and a name of a network service is extracted therefrom to determine an original destination.

In an example, resolving the original domain name corresponding to the target domain name from the virtual address includes: extracting an identifier corresponding to the original domain name from a socket of the private network; and resolving the original domain name from the virtual address based on the identifier.

In this example, the identifier corresponding to the original domain name may be resolved from the socket of the private network, and the original domain name may be resolved from the virtual address based on the identifier, where the socket may be a socket, and the identifier may be a MarkId.

In an example, a network service may exchange a piece of mark information (markId) with an existing gateway control plane component in the gateway orchestration service. After obtaining the markId, a socket may be created, and the markId may be embedded into the socket. A network security management proxy can extract the markId from the socket through a Traffic Control (TC) rule and place it into the last 24 bits of a destination Media Access Control (MAC) address of a network packet. A gateway data plane component may finally resolve the target network service based on the destination MAC address, and derive the original domain name from the virtual address based on the identifier.

In an example, the step S210 of accessing the network resource in the private network based on the original domain name of the private network corresponding to the target domain name includes: accessing the private network based on a virtual extensible local area network, and accessing the network resource in the private network according to the original domain name.

In this example, the private network may be accessed based on the Virtual extensible Local area network (VxLan), and the resource in the private network may be accessed according to the original domain name.

In an example, the original domain name is resolved from the virtual address based on the identifier, and the network service is connected through the VxLan, thereby realizing the network connectivity to the private network.

In an example, a duration of a disconnection between the client and the virtual address is obtained, and the virtual address is deleted in response to the disconnection duration exceeding a duration threshold.

In this embodiment, the duration of the disconnection between the client and the virtual address may be obtained, and if the disconnection duration exceeds the duration threshold, the virtual address may be deleted. Here, the duration threshold may be a value set based on actual requirements, for example, it may be 100 seconds. This is only an example and does not impose specific restrictions. The disconnection duration may be a cache time of a domain name (Time To Live, abbreviated as TTL).

In an example, a domain name resolution aging mechanism may be designed by using the transport proxy and the DNS proxy. The cache time of a domain name returned by the DNS proxy may be set, and the domain name will automatically age out once the cache time expires. This eliminates the need for users to maintain port mapping resources, thereby avoiding resource waste.

For example, the cache time of the domain name returned by the DNS proxy may be set to 60 seconds. The transport proxy will expire and age out the VIP after 60 seconds of disconnection, eliminating the need for users to maintain port mapping resources and avoiding resource waste.

In an example, obtaining a domain name resolution request from a client includes: obtaining the domain name resolution request from a service container of the client in a network proxy container, where the network proxy container and the service container share a same operating cycle and the client accesses a private network through the service container. Resolving a target domain name of the private network from a virtual address in response to a resource access request from the client includes: in response to a resource access request from the service container of the client, resolving the target domain name from the virtual address.

In this example, the client may access the private network through the service container. The service container from the client may be obtained in the network proxy server, enabling the network proxy container and the service container to share the same operating cycle. Thus, the client may access the private network through the service container.

In an example, the target domain name may be resolved from the virtual address in response to a resource access request from a service container of the client.

In an example of the present disclosure, the network proxy container intercepts the traffic of the service container to establish the network connectivity. The private network is encoded in the domain name, and the network proxy container interception technology is used to achieve network penetration of the service container. This reduces the access cost on an application, thereby achieving the technical effect of improving the efficiency of network connectivity, and solving the technical problem of low efficiency of network connectivity.

In an example of the present disclosure, a domain name format conforming to a private network is determined based on a domain name resolution request of a client. A virtual address corresponding to the domain name format is determined based on the domain name format of the private network. A resource access request conforming to the domain name format sent by the client is obtained, and a target domain name of the private network is resolved from the virtual address based on the resource access request. Based on an original domain name of the private network corresponding to the target domain name, the network resources in the private network may be accessed. This achieves the technical effect of improving the network connectivity efficiency, and solves the technical problem of low network connectivity efficiency.

The following describes the method for accessing a private network from the perspective of encoding the domain name.

FIG. 3 is a flowchart of another method for accessing a private network according to an example of the present disclosure. As shown in FIG. 3, the method may include the following steps.

In step S302, an original domain name of a private network is obtained, where the original domain name is used for characterizing an original address of the private network.

In the technical solution provided in the above step S302 of the present disclosure, the original domain name of the private network may be obtained, where the original domain name may be used for characterizing an original address of the private network, and the original address may be a name of a created network service, for example, vpc1.

In an example, an administrator may create a network service and complete the preparation of the network service. It may be assumed that a name of the network service is a resource name (vpc1) of a private network, so that an original domain name of the private network is obtained, where the network service may be used to complete the processing and forwarding of resources in the private network.

In step S304, the original domain name is encoded according to a domain name format of the private network to obtain a target domain name of the private network, where the target domain name is used for characterizing a target address of the private network.

In the technical solution provided in the above step S304 of the present disclosure, the original domain name may be encoded according to the domain name format of the private network to obtain the target domain name of the private network, where the target domain name may be used for characterizing the target address of the private network.

In an example, the original domain name may be encoded according to the domain name format of the private network. For example, a network tag (vpc1. . . . ) may be appended to an original destination address (original domain name). The newly added network tag may consist of the name of the network service (vpc1) and some additional parameters, so that it becomes a new destination address (the target domain name of the private network) characterized by a domain name. Based on this target domain name, a resource in other networks can be accessed to reach a desired destination.

In step S306, the target domain name is issued to the client, so that the client sends, based on the target domain name, a domain name resolution request conforming to the domain name format and a resource access request conforming to the domain name format. Here, the domain name resolution request is used to allocate a virtual address corresponding to the domain address format to the private network, and the resource access request is used to resolve the target domain name of the private network from the virtual address, and the original domain name corresponding to the target domain name is used to access network resources in the private network.

In the technical solution provided in the above step S306 of the present disclosure, the target domain name may be issued to the client, so that the client may send a domain name resolution request conforming to the domain name format and a resource access request conforming to the domain name format based on the target domain name. A virtual address corresponding to the domain name format may be allocated to the private network based on the domain name resolution request. The target domain name of the private network may be resolved from the virtual address based on the resource access request. The original domain name corresponding to the target domain name may be used to access network resources in the private network.

In an example, an application may achieve the purpose of establishing network connectivity by accessing an encoded domain name (new destination address). And the domain name of the private network may be encoded into the original destination address to achieve the purpose of easily accessing the target private network. Where the encoding may be completed in advance before the target domain name is issued to the application.

For example, a web address (such as https://www.taobao.com) may be opened in a browser, the web address is resolved by a domain name resolution server to obtain an Internet protocol address of a domain name ‘www.taobao.com’ for machine recognition. The browser may, based on the recognized Internet protocol address, initiate a domain name resolution request conforming to the domain name format and a resource access request conforming to the domain name format to a specific Internet protocol address.

Through the steps S302 to S306 of the present disclosure, an original domain name of a private network is obtained, where the original domain name is used for characterizing an original address of the private network. A target domain name of the private network is obtained by encoding the original domain name according to the domain name format of the private network, where the target domain name is used for characterizing a target address of the private network. The target domain name is issued to a client, so that the client sends a domain name resolution request conforming to the domain name format and a resource access request conforming to the domain name format based on the target domain name. The domain name resolution request is used for allocating a virtual address corresponding to the domain name format to the private network, the resource access request is used for resolving the target domain name of the private network from the virtual address, and the original domain name corresponding to the target domain name is used for accessing network resources in the private network. This achieves the technical effect of improving the network connectivity efficiency, and solves the technical problem of low network connectivity efficiency.

An example of the present disclosure further provides another method for accessing a private network, and the method may be applied to a Software-as-a-Service (Saas).

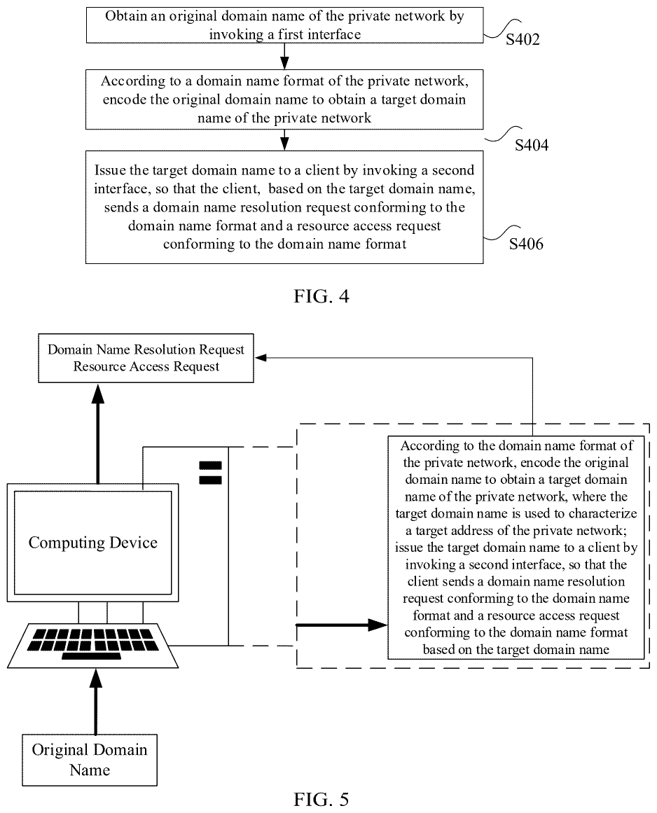

FIG. 4 is a flowchart of another method for accessing a private network according to an example of the present disclosure. As shown in FIG. 4, the method may include the following steps.

In step S402, an original domain name of a private network is obtained by invoking a first interface, where the first interface includes a first parameter, a parameter value of the first parameter is the original domain name, and the original domain name is used for characterizing an original address of the private network.

In the technical solution provided in the above step S402 of the present disclosure, the first interface may be an interface for data interaction between a server and a client, and the client may use the original domain name of the private network as the first parameter of the first interface. Thus, the purpose of obtaining the original domain name of the private network can be achieved.

In step S404, the original domain name is encoded according to a domain name format of the private network to obtain a target domain name of the private network, where the target domain name is used for characterizing a target address of the private network.

In step S406, the target domain name is issued to a client by invoking a second interface, so that the client sends, based on the target domain name, a domain name resolution request conforming to the domain name format and a resource access request conforming to the domain name format, where the second interface includes a second parameter, and the parameter value of the second parameter is the target domain name. The domain name resolution request is used for allocating a virtual address corresponding to the domain name format to the private network. The resource access request is used for resolving the target domain name of the private network from the virtual address. And an original domain name corresponding to the target domain name is used for accessing network resources in the private network.

In the technical solution provided in the above step S406 of the present disclosure, the second interface may be an interface for data interaction between the server and the client. The server may issue the target domain name to the client, so that the client, based on the target domain name, sends a domain name resolution request conforming to the domain name format, and a resource access request conforming to the domain name format to the second interface, as a parameter of the second interface, to achieve the purpose of sending the domain name resolution request conforming to the domain name format and the resource access request conforming to the domain name format to the client.

FIG. 5 is a schematic diagram illustrating a computer device accessing a private network according to an example of the present disclosure. As shown in FIG. 5, an original domain name of a private network may be obtained by invoking a first interface, and the computer device encodes the original domain name according to a domain name format of the private network to obtain a target domain name of the private network. Where the target domain name is used for characterizing a target address of the private network, and is issued to a client by invoking a second interface, so that the client sends a domain name resolution request conforming to the domain name format and a resource access request conforming to the domain name format according the target domain name. The obtained domain name resolution request conforming to the domain name format and the resource access request conforming to the domain name format may be output by invoking the second interface.

In an example, a platform may output the obtained domain name resolution request conforming to the domain name format and the resource access request conforming to the domain name format by invoking the second interface, where the second interface may be used to issue the target domain name to the client, so that the client sends the domain name resolution request conforming to the domain name format and the resource access request conforming to the domain name based on the target domain name.

In an example of the present disclosure, an original domain name of a private network is obtained by invoking a first interface, where the first interface includes a first parameter, the parameter value of the first parameter is the original domain name, and the original domain name is used to characterize an original address of the private network. The original domain name is encoded according to a domain name format of the private network to obtain a target domain name of the private network, where the target domain name is used for characterizing a target address of the private network. The target domain name is issued to a client by invoking a second interface, so that the client sends a domain name resolution request conforming to the domain name format and a resource access request conforming to the domain name format based on the target domain name, where the second interface includes a second parameter, the parameter value of the second parameter is the target domain name. The domain name resolution request is used for allocating a virtual address corresponding to the domain name format to the private network. The resource access request is used for resolving the target domain name of the private network from the virtual address. And the original domain name corresponding to the target domain name is used for accessing network resources in the private network. This achieves the technical effect of improving the network connectivity efficiency, and solves the technical problem of low network connectivity efficiency.

### Example 2

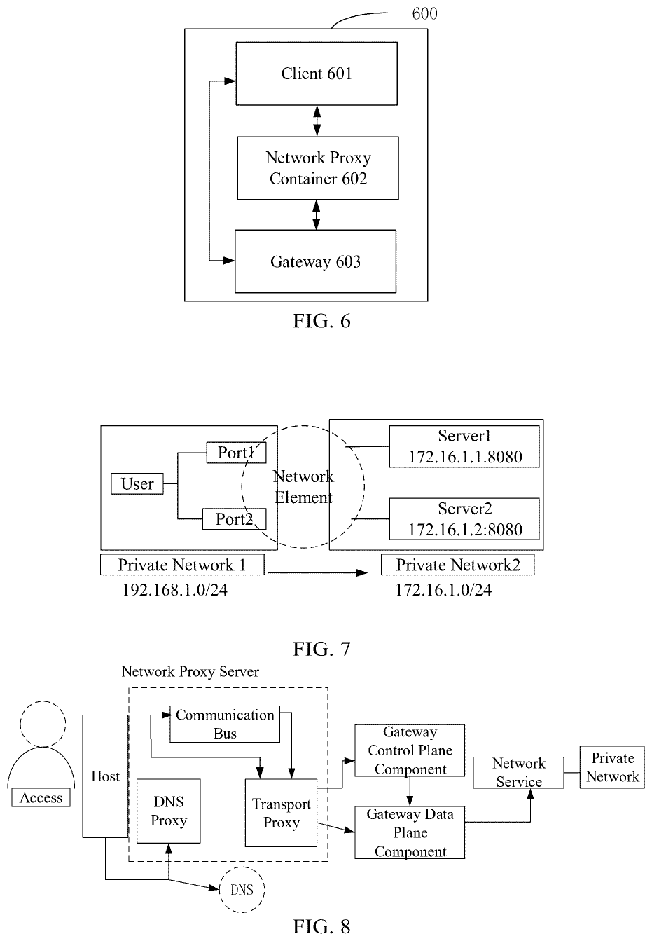

According to an example of the present disclosure, an example of a private network access system is further provided. FIG. 6 is a schematic diagram illustrating a private network access system according to an example of the present disclosure. As shown in FIG. 6, the system may include: a client 601, a network proxy container 602 and a gateway 603.

The client 601 may be configured to send a domain name resolution request to a network proxy container, where the client may be an accessing end to access a gateway, for example, an application.

The network proxy container 602 may be configured to determine that the domain name resolution request conforms to a domain name format of the gateway, and may allocate a virtual address corresponding to the domain name format to the gateway. In response to a resource access request from the client, the network proxy container 602 may resolve a target domain name of the gateway from the virtual address, where the resource access request may conform to the domain name format, and the target domain name may be used for characterizing a target address of the private network. The network proxy container 602 may access a network resource in the gateway based on an original domain name of the gateway corresponding to the target domain name, where the domain name format may be used to encode the original domain name into the target domain name, the original domain name may be used for characterizing an original address of the private network. Here, the network proxy container may be a network proxy container configured to provide additional functions for a main network proxy container. For example, the network proxy container may be a network proxy container in a network security manager proxy (abbreviated as nsm proxy).

The gateway 603 may be configured to return the network resource to the network proxy container, and may be a VPC gateway.

In an example, the network proxy container may include: a request interception component, which may be configured to detect whether a domain name resolution request includes an original domain name, and a name and/or type of a network resource. If it is detected that the domain name resolution request includes the original domain name, and the name the network resource and/or type of the network resource, it may be determined that the domain name resolution request conforms to a domain name format, where the name of the network resource and/or the type of the network resource may be located at the tail of the original domain name in the domain name resolution request.

In an example, the request interception component may be a domain name server (abbreviated as DNS Proxy), which may be used to intercept a domain name resolution request of the network proxy container, and may initiate a hypertext transfer protocol (http (s)) request after completing the domain name resolution, and return a virtual IP address.

In an example, the network proxy container may include a transmission component that may be configured to determine a first network segment where the client is currently located, and determine a second network segment different from the first network segment, and may assign a virtual address located on the second network segment that corresponds to the domain name format to the private network.

In an example, the transmission component may be a transport-proxy and may be used to resolve an original destination from the virtual IP address and access a data stream into a data plane of a gateway orchestration service.

In an example, the network proxy container may include a sanitizing component, which may be configured to sanitize a resource access request in response to the resource access request being transmitted according to a hypertext transfer protocol, where the sanitized resource access request may conform to an original domain name format of the private network.

In an example, the transmission component may be further configured to resolve an original domain name corresponding to the target domain name from the virtual address based on the sanitized resource access request.

In an example, the sanitizing component may be a communication bus (envoy) that may be used to sanitize http(s) requests, and change a host field of the hypertext transfer protocol back to the original address before encoding to avoid problems with virtual host matching. Meanwhile, the sanitizing component may remove an encoding part in a Server Name Indication (SNI) of the transport security protocol (Transport Layer Security, abbreviated as TLS) to avoid a handshake failure of the transport security protocol.

In an example of the present disclosure, on the basis of a gateway orchestration service, a network proxy container (Sidecar) is added, and the network proxy container can be automatically injected into a service container through a network hook (webhook) or the creation capability of the network proxy container of a cloud-native application automation engine. This achieves the technical effect of improving the efficiency of network connectivity, and solves the technical problem of low efficiency of network connectivity.

In this example, a system for accessing a private network is provided, where a client is used for sending a domain name resolution request to a network proxy container; the network proxy container is used for determining that the domain name resolution request conforms to a domain name format of a gateway, and allocating a virtual address corresponding to the domain name format to the gateway, and in response to a resource access request from the client, resolving a target domain name of the gateway from the virtual address, and accessing network resources in the gateway based on an original domain name of the gateway corresponding to the target domain name; and the gateway is used for returning the network resources to the network proxy container. Thus, a domain name format conforming to the private network may be determined based on the domain name resolution request of the client, a virtual address corresponding to the domain name format may be determined based on the domain name format of the private network, a resource access request conforming to the domain name format sent by the client may be obtained, the target domain name of the private network may be resolved from the virtual address based on the resource access request, and the network resources in the private network may be accessed based on the original domain name of the private network corresponding to the target domain name, thereby realizing the technical effect of improving the network connectivity efficiency, and solving the technical problem of low network connectivity efficiency.

Example 3

At present, for the problem of a client accessing a service in another private network, the client accessing the service in another private network may be realized by establishing three-layer connectivity between the network of the client and the server. For example, solutions such as Cloud Enterprise Network (abbreviated as CEN) and virtual private cloud are all based on three-layer network connectivity to solve the problem of an application in a client accessing a service in another private network. However, the three-layer network connectivity will change the basic network environment in the application. For example, a new routing rule needs to be added, but the new routing rule will conflict with network segments of an existing network. This method has the problems such as the configuration efficiency being low and a number of connected private network being limited. Further, the method has strict restrictions on the Classless Inter-Domain Routing (abbreviated as CIDR) division of each network, leading to issues of incomplete overlap.

In the related art, a port mapping-based connectivity solution has also been proposed, which addresses the issue of accessing services in a private network by means of port mapping. For example, methods such as Destination Network Address Translation (DNAT), Private Link are used. FIG. 7 is a schematic diagram illustrating a port mapping process according to the related art. As shown in FIG. 7, the method needs to provide a network element (proxy) in a network layer to enable communication between two networks. This network element may provide a protocol+IP+port that is accessible within a local private network 1. When all requests from the local private network arrive at this port, they will be forwarded to a certain protocol+IP+port in the peer network (for example, private network 2).

For example, as shown in FIG. 7, a protocol+IP+port (192.168.1.100:80) accessible within the local private network 1 may be provided at a port 1 of the gateway. When a user (client) sends a request 1 in the private network 1 (192.168.1.0/24), the request 1 will be forwarded to a server 1 with a protocol+IP+port (172.16.1.1:8080) in the private network 2 (172.16.1.0/24) after reaching the port 1.

For another example, as shown in FIG. 7, a protocol+IP+port (192.168.1.100:8080) accessible within the local private network 1 may be provided at a port 2 of the gateway. When the client sends a request 2 in the private network 1 (192.168.1.0/24), the request 2 will be forwarded to a server 2 with a protocol+IP+port (172.16.1.2:8080) in the private network 2 after reaching the port 2.

It can be seen from the above that the port mapping connectivity method needs to change the address and the port of the original destination. If there are some routing matching rules based on a host (for example, a virtual host of a reverse proxy service (nginx)) in a service address, the server name indication (TLS SNI) of a transport security protocol will fail, and every time a destination is added, it is necessary to establish port connectivity on the corresponding network configuration, which has the problem of low configuration efficiency and may cause the maximum accessible destinations to be limited by the capacity of central network facilities. Therefore, the method is not suitable for a case where massive short requests need to be processed. Furthermore, the method requires self-attention to port life cycles, otherwise there is a risk that port resources may be easily leaked. In addition, the application developers usually have no permissions to a mapping configuration behavior to operate the port mapping, as this task is handled by a cluster administrator, thereby leading to application inflexibility.

The related art also provides a connectivity based on an application proxy manner, such as a Hypertext Transfer Protocol proxy (HTTP proxy) and a network transfer protocol proxy (socks5 proxy). This method requires significant modifications to user code, and its applicability is limited by whether a Software Development Kit (SDK) supports such proxy, resulting in a constrained scope of use. In production environments, when in a multi-tenant scenario, a single Pod may need to simultaneously access multiple private networks, and the number of private networks increases with the growth of tenants. Consequently, this method still suffers from high access costs.

In order to solve the limitations in the related art, where client access to a service in another private network is hindered by high access costs and low scheme flexibility, and an inability to meet the requirements of multi-tenant production environments, an example of the present disclosure proposes a method for establishing connectivity to a private network by using domain name encoding. This method achieves network connectivity by using a DNS server to encode domain names, where the DNS server may be used to translate domain names and their corresponding IP addresses.

In an example of the present disclosure, if an application wants to access a resource in a private network, it is only required to modify an access destination. For example, a network tag can be added after an original destination address to obtain a new destination address characterized by a domain name, so that the application can access resources in another network. Where the newly added network tag may consist of a name of a network service and some additional parameters, and the encoding can be done in advance before the domain name is issued to the application. However, in most cases, the code for accessing a service does not need to be modified.

A further introduction to the device for establishing connectivity to a private network by using the domain name encoding proposed in an example of the present disclosure is made in the following.

In the example of the present disclosure, based on a gateway orchestration service, a network proxy container (Sidecar container) is added, and the network proxy container can be automatically injected into a service container through a network hook (webhook) or the creation (Sidecar Set) capability of the network proxy container of a cloud-native application automation engine.

FIG. 8 is a schematic diagram illustrating a system for establishing connectivity to a private network according to an example of the present disclosure. As shown in FIG. 8, the gateway orchestration service may include a gateway control plane component (Network Service Manager, abbreviated as NSMgr) for interfacing with a VxLan and a gateway data plane component (Forwarder). The gateway orchestration service may abstract a private network as a network service resource to realize interfacing with a virtual extensible local area network (VxLan), thereby achieving access to other private networks (such as internal.a.com). The underlying implementation of the network service may include a set of containers (Pods) located in a target private network. These containers may provide access to nodes in other private networks through the VxLan mechanism.

In an example, since the example of the present disclosure is constructed based on the gateway orchestration service, the method can also be applied to other scenarios with establishment of three-layer network connectivity.

In this example, the network security management proxy (abbreviated as nsm-proxy) may consist of three parts of a DNS proxy, a transport proxy, and a communication bus.

In an example, the DNS proxy may be configured to intercept a domain name resolution request of a container, and may initiate a hypertext transfer protocol (http(s)) request after completing the domain name resolution, and return a virtual IP address.

In an example, the communication bus may be configured to sanitize a http(s) request, and change a host field of the hypertext transfer protocol back to the original address before encoding, so as to avoid problems in virtual host matching. At the same time, the communication bus may remove an encoding part in a server name indication of the transport security protocol, so as to avoid handshake failure of the transport security protocol.

In an example, a transport proxy may be configured to resolve a virtual IP address back to the original destination and access a data stream into the data plane of the gateway orchestration service.

Based on the device for establishing connectivity to a private network by using domain name encoding, the following provides further description on the device for establishing connectivity to the private network by using domain name encoding proposed in the example of the present disclosure.

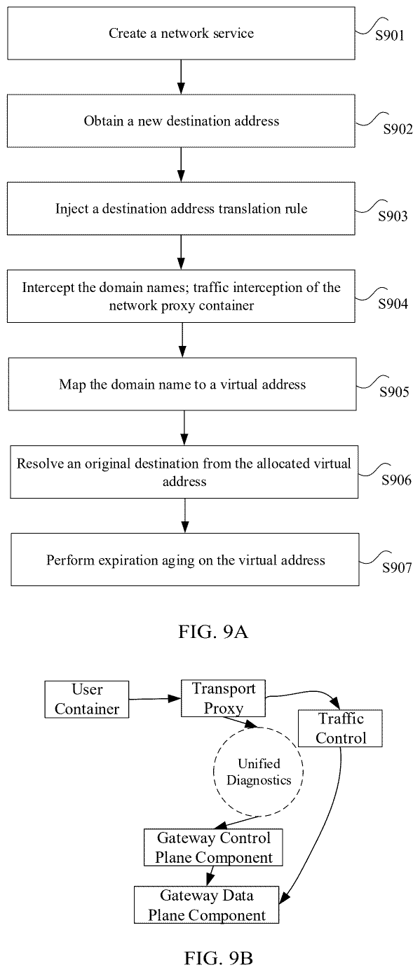

FIG. 9A is a flowchart of a method for establishing connectivity to a private network according to an example of the present disclosure. As shown in FIG. 9A, the method for establishing connectivity to a private network may include the following steps.

In Step S901, a network service is created.

In this example, the network service may be created by an administrator to complete the service provisioning. It may be assumed that a name of the network service is a resource name (vpc1).

In step S902, a new destination address is obtained.

In this example, before being issued to an application, the network service may be encoded. For example, a network tag (vpc1. . . . ) may be appended to an original destination address of the network service. The newly added network tag may consist of the name of the network service (vpc1) and some additional parameters, to obtain a new destination address characterized by a domain name. This enables access to a resource in other networks to reach a desired destination.

In an example, the application may achieve the purpose of establishing connectivity to the network by accessing the encoded domain name (the new destination address), and achieve the purpose of easily accessing a target private network by encoding the domain name of the private network into the original destination address.

For example, nodes in other private networks accessing network services may use format 1 (non-http(s) request) and format 2 (http(s) request). In an example, an original destination hostname of format 1 may be:/IP. . . .

For example, an online database service (Relational Database Service, RDS for short) named vpc1 in network services may be accessed, where an origin address (domain name) may be rds.a.com. The encoded address, after incorporating the name and additional parameters of the network service, can be: rds.a.com.vpc1. . . . , where vpc1. . . . may be in a hostname format.

For another example, an HTTP service named vpc1 in the network services is accessed, where an original address (domain name) of the HTTP service may be www.a.com, and the encoded address (domain name), after incorporating the original address and additional parameters, may be www.a.com.vpc1.http. . . .

It should be noted that the above encoding contents and types are only examples, and are not specifically limited here.

In step S903, a destination address translation rule is injected.

In this example, when a network proxy container of a network security management proxy is started, a Destination Network Address Translation (DNAT) rule may be injected into the container. Where the Destination Network Address Translation (DNAT) is one of firewall port mapping methods. After injecting the Destination Network Address Translation rule, the port traffic of accessing a certain destination address or certain destination addresses can be transferred to a specific IP+port.

In an example, in a domain name resolution phase, as shown in FIG. 8, requests to a user datagram protocol (UDP) 53 port and a transmission control protocol (TCP) 53 port of a user access may all be forwarded to DNS proxy (127.0.0.1:5353) to intercept a domain name resolution request of a container and return a virtual IP address. Therefore, the requests from any address to the UDP 53 port and the TCP 53 port can be redirected to the 127.0.0.1:5353 port of the DNS proxy, where the domain name resolution request may be an access request at a domain name resolution node. It should be noted that the above numbers are only illustrative examples, and are not restrictive.

In an example, a domain name resolution request may be obtained. A domain name may be resolved, and the resolved domain name may be converted into an IP address, so that the client may connect to a remote server based on the IP address. A resource request (http(s) request) can only be initiated to an Internet protocol address only after the Internet protocol address is obtained by resolving the domain name.

For example, a web address (for example, https://www.taobao.com) may be opened on a browser. The web address is resolved by a domain name resolution server to obtain an Internet protocol address of the domain name www. taobao. com to facilitate machine recognition. The browser may, based on the recognized Internet protocol address, initiate an access request to a specific Internet protocol address.

In step S904, a domain name is intercepted, and traffic of the network proxy container is intercepted.

In this example, a format of a domain name may be analyzed by a DNS proxy. If a domain name resolution request does not conform to the format of the gateway orchestration service (which may include format 1 and format 2), the DNS proxy may directly forward the request to a local address of a socket; if the domain name format of the domain name resolution request conforms to the format of the gateway orchestration service, the DNS proxy will allocate a virtual Internet protocol address to a transport proxy, where a network segment of the VIP will be selected as a segment that does not conflict with a network segment of a user cluster, for example, 21.0.0.0/8. The network segment here is only an example without specific limitation.

In step S905, the domain name is mapped to a virtual address.

In this example, after a domain name resolution request in a domain server instruction (DNS Query) from a user is returned, the application may initiate a request (http request) to the virtual IP address (VIP) allocated by the transport proxy. An IP segment where the VIP is located may hit a designed transparent proxy (abbreviated as tproxy) rule.

In an example, as shown in FIG. 8, if the request is a non-http request, the traffic may directly enter the transport proxy through the tproxy rule; if the request is an http request, the traffic may, through the tproxy rule, first enter an envoy and then enter the transport proxy.

For example, as shown in FIG. 8, for an http request (e.g., www.a.com.vpc1.http. . . . ), the envoy may remove the format of the gateway orchestration service in the host and Server Name Indication (SNI for short). The host field of http can be changed back to the original address before encoding to avoid the problem of virtual host matching. At the same time, an encoded part in TLS SNI may be removed to avoid TLS handshake failure. The mark: 2676 can be set in the socket to prevent the sent traffic from returning to the communication bus. The requests sent by the communication bus to the outside will be transmitted to the transport proxy by the transparent proxy.

In step S906, the original destination is resolved from the allocated virtual address.

In this example, the transport proxy may resolve the allocated VIP to obtain the encoded domain name, and resolve the name of the network service from the domain name to determine the original destination.

FIG. 9B is a schematic diagram illustrating resolving an original network service according to an example of the present disclosure. As shown in FIG. 9B, the resource access request may be diagnosed by Unified Diagnostic Services (UDS). The network service may exchange a piece of mark information (MarkId) with an existing gateway control plane component in the gateway orchestration service. A socket is created after the MarkId is obtained. The markId is embedded into the socket. A network security management proxy may extract the markId from the socket through a Traffic Control (TC) rule and places it into the last 24 bits of a Media Access Control (MAC) address of a network packet. The gateway data plane component may finally resolve the target network service through the destination MAC address, and connect to the network service through VxLan, thus realizing network connectivity.

In step S907, expiration aging is performed on the virtual address.

In this example, a domain name resolution aging mechanism may be designed by using the transport proxy and the DNS proxy. The cache time of the domain name returned by the DNS proxy may be set, and the domain name will be automatically aged out once the cache time expires, so that a user does not need to maintain the resources for port mapping, thereby avoiding resource waste.

For example, the cache time of the domain name returned by the DNS proxy may be 60 seconds, and the transport proxy server will age the VIP out after the VIP has been disconnected for 60 seconds, so that the user does not need to maintain the resources for port mapping, thereby avoiding resource waste.

According to the example of the disclosure, a DNS technology is adopted. By encoding the domain name of the private network into the original destination address, and intercepting the traffic of a service container with the Sidecar technology, the network connectivity is established. The private network is encoded in a domain name. The Sidecar traffic interception technology is adopted to complete the network connectivity of the service container. As DNS is a technology supported by mainstream operating systems, mainstream programming languages and SDKs by default, therefore the costs of access to applications are reduced.

In the related art, in order to access a destination, it is required to consume a global port (for example, a port mapping method), while in the example of the present disclosure, after the network service is prepared, the domain name interception and VIP mapping work are performed locally, so that it is easy to access tens of thousands of destinations in the target private networks. And the present solution also has an elimination mechanism based on connection expiration, which does not need a user to maintain resources for port mapping, and is friendly to massive short task requests, thereby achieving the technical effect of improving the network connectivity efficiency, and solving the technical problem of low network connectivity efficiency.

In another example, FIG. 10 is a block diagram illustrating an example of using the computer terminal (or mobile device) in FIG. 1 as a service mesh. FIG. 10 is a structural block diagram illustrating a service mesh of a method for accessing a private network according to an example of the present disclosure. As shown in FIG. 10, the service mesh 1000 is mainly configured to facilitate secure and reliable communication among a plurality of microservices. The microservice refers to decomposing an application into a plurality of smaller services or instances and distributing the services or instances to run on different clusters/machines.

As shown in FIG. 10, the microservices may include an application service instance A and an application service instance B, which form a functional application layer of the service mesh 1000. In an example, the application service instance A runs in a form of container/process 1008 in a machine/workload container set 1014 (POD), and application service instance B runs in a form of container/process 1010 in a machine/workload container set 1016 (POD).

In an example, the application service instance A may be a product inquiry service, and the application service instance B may be a product ordering service.

As shown in FIG. 10, the application service instance A and mesh proxy (sidecar) 1003 coexist in the machine workload container set 1014, and application service instance B and mesh proxy 1005 coexist in machine/workload container set 1014. The mesh proxy 1003 and the mesh proxy 1005 form a data plane of the service mesh 1000. The mesh proxy 1003 and the mesh proxy 1005 are run respectively in the form of a container/process 1004 and in the form of a container/process 1006. The container/process 1004 may receive a request 1012 for performing a product inquiry service. The mesh proxy 1003 and application service instance A may communicate bi-directionally. The mesh proxy 1005 and application service instance B may communicate bi-directionally. Additionally, the mesh proxy 1003 and the mesh proxy 1005 may communicate bi-directionally.

In an example, all network traffic for the application service instance A is routed to an appropriate destination through the mesh proxy 1003, and all network traffic for application service instance B is routed to an appropriate destination through the mesh proxy 1005. It should be noted that network traffic referred to herein includes, but is not limited to, Hypertext Transfer Protocol (HTTP), Representational State Transfer (REST), high-performance, general-purpose open source framework (gRPC), open source in-memory data structure storage system (Redis) and other forms.

In an example, functions of the data plane layer may be extended by writing a custom filter for an envoy in the service mesh 1000. The service mesh envoy may be configured to enable the service mesh to proxy service traffic correctly, so as to realize service interoperability and service governance. The mesh proxy 1003 and 1005 may be configured to perform at least one function of: service discovery, health checking, routing, load balancing, authentication and authorization, and observability.

As shown in FIG. 10, the service mesh 1000 also includes a control plane layer. Where the control plane layer may be a set of services running in a dedicated namespace. The services are hosted by a host control plane component 1001 in a machine/workload container set 1002. As shown in FIG. 10, the host control plane component 1001 is in bi-directional communication with the mesh proxy 1003 and the mesh proxy 1005. The host control plane component 1001 is configured to perform some control management functions. For example, the host control plane component 1001 receives telemetry data transmitted by the mesh proxy 1003 and the mesh proxy 1005, and may further aggregate the telemetry data. The host control plane component 1001 may further provide a user-oriented application interface (API) to make manipulation of network behavior easier, and provide configuration data to the mesh proxy 1003 and the mesh proxy 1005, and the like.

It should be noted that the foregoing method examples are described as a series of combinations of actions for the sake of simplicity. But those skilled in the art should be aware that the present disclosure is not limited by the order of the described actions, as some steps may be performed in other orders or simultaneously according to the present disclosure. Secondly, those skilled in the art should also be aware that the examples described in the specification are all preferred examples, and the actions and modules involved are not necessarily required for the present disclosure.

Through the descriptions of the above examples, those skilled in the art can clearly understand that the method according to the above examples can be implemented by means of software and a necessary general hardware platform, of course, it can also be implemented by means of hardware, but in many cases, the former is a better implementation. Based on such understanding, the technical solution of the present disclosure, in essence or the portion contributing to the related art may be embodied as the form of a computer software product. The computer software product is stored in a storage medium (such as ROM/RAM, a magnetic disk, or an optical disk), and comprises several instructions for enabling a terminal device which may be a mobile phone, a computer, or a server or a network device, etc. to perform the method according to each of the various examples of the present disclosure.

### Example 4

According to an example of the present disclosure, an apparatus for accessing a private network for performing the method shown in FIG. 2 is further provided.

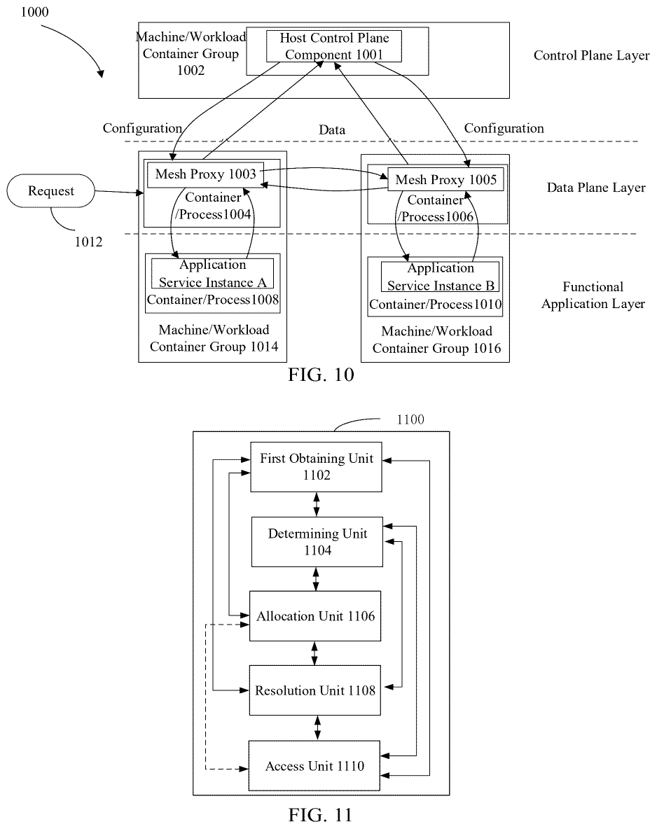

FIG. 11 is a schematic diagram of an apparatus for accessing a private network according to an example of the present disclosure. As shown in FIG. 11, the apparatus 1100 for accessing a private network may include a first obtaining unit 1102, a determining unit 1104, an allocation unit 1106, a resolution unit 1108, and an access unit 1110.

The first obtaining unit 1102 is configured to obtain a domain name resolution request from a client, where the client is an accessing end to access the private network.

The determining unit 1104 is configured to determine that the domain name resolution request conforms to a domain name format of the private network.

The allocation unit 1106 is configured to allocate a virtual address corresponding to the domain name format to the private network.

The resolution unit 1108 is configured to resolve a target domain name of the private network from the virtual address in response to a resource access request from the client, where the resource access request conforms to the domain name format, and the target domain name is used for characterizing a target address of the private network.

The access unit 1110 is configured to access a network resource in the private network based on an original domain name of the private network corresponding to the target domain name, where the domain name format is used for encoding the original domain name into the target domain name, and the original domain name is used for characterizing an original address of the private network.

It should be noted here that the first obtaining unit 1102, the determining unit 1104, the allocation unit 1106, the resolution unit 1108, and the access unit 1110 correspond to steps S202 to S210 in Example 1, and the instances and application scenarios of implemented by the five units are the same, but not limited to those implemented by the corresponding steps. It should be noted that the above units, as a part of the apparatus, may run in the computer terminal provided in Example 1.

According to an example of the present disclosure, an apparatus for accessing a private network for implementing the method shown in FIG. 3 is further provided.

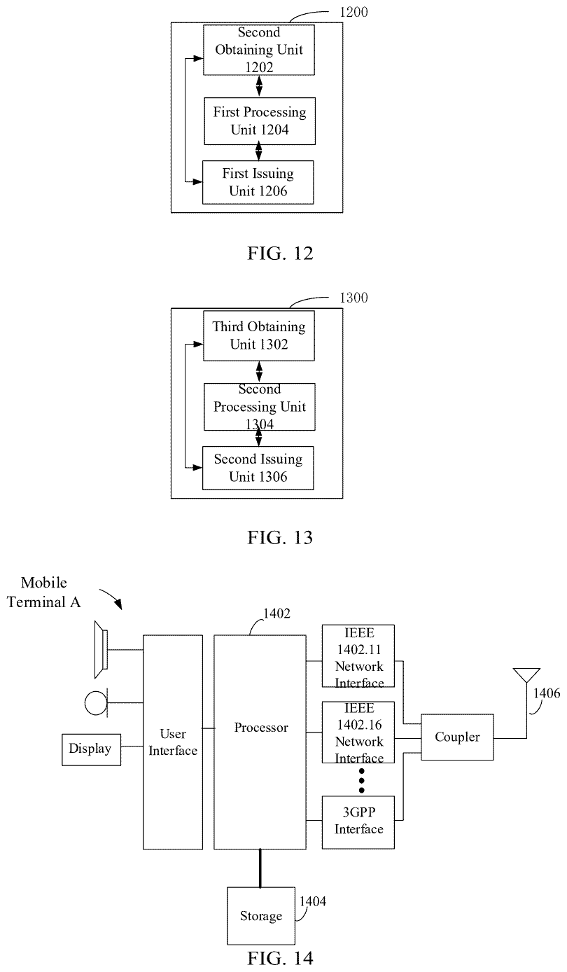

FIG. 12 is a schematic diagram illustrating another apparatus for accessing a private network according to an example of the present disclosure. As shown in FIG. 12, the apparatus 1200 for accessing a private network may include a second obtaining unit 1202, a first processing unit 1204, and a first issuing unit 1206.

The second obtaining unit 1202 is configured to obtain an original domain name of the private network, where the original domain name is used for characterizing an original address of the private network.

The first processing unit 1204 is configured to encode the original domain name according to a domain name format of the private network, so as to obtain a target domain name of the private network, where the target domain name is used to characterize a target address of the private network.

The first issuing unit 1206 is configured to issue the target domain name to a client, so that the client sends, based on the target domain name, a domain name resolution request conforming to the domain name format and a resource access request conforming to the domain name format, where the domain name resolution request is used for allocating a virtual address corresponding to the domain name format to the private network; the resource access request is used for resolving the target domain name of the private network from the virtual address, and the original domain name corresponding to the target domain name is used for accessing a network resource in the private network.

It should be noted here that the second obtaining unit 1202, the first processing unit 1204, and the first issuing unit 1206 correspond to the steps S302 to S306 in Example 1, and the instances and application scenarios of implemented by the three units are the same, but not limited to those implemented by the corresponding steps. It should be noted that the above units, as a part of the apparatus, may run in the computer terminal provided in Example 1.

According to an example of the present disclosure, an apparatus for accessing a private network for performing the method shown in FIG. 4 is further provided.

FIG. 13 is a schematic diagram illustrating another apparatus for accessing a private network according to an example of the present disclosure. As shown in FIG. 13, the apparatus 1300 for accessing a private network may include a third obtaining unit 1302, a second processing unit 1304, and a second issuing unit 1306.

The third obtaining unit 1302 is configured to obtain an original domain name of the private network by invoking a first interface, where the first interface includes a first parameter, a parameter value of the first parameter is the original domain name, and the original domain name is used for characterizing an original address of the private network.

The second processing unit 1304 is configured to encode the original domain name according to a domain name format of the private network, so as to obtain a target domain name of the private network, where the target domain name is used for characterizing a target address of the private network.

The second issuing unit 1306 is configured to issue the target domain name to a client by invoking a second interface, so that the client, based on the target domain name, sends a domain name resolution request conforming to the domain name format and a resource access request conforming to the domain name format, where the second interface includes a second parameter, and a parameter value of the second parameter is the target domain name. The domain name resolution request is used for allocating a virtual address corresponding to the domain name format to the private network, the resource access request is used for resolving the target domain name of the private network from the virtual address, and the original domain name corresponding to the target domain name is used for accessing a network resource in the private network.

It should be noted here that the third obtaining unit 1302, the second processing unit 1304, and the second issuing unit 1306 correspond to the steps S402 to S406 in Example 1, and the three units are the same, but not limited to those implemented by the corresponding steps. It should be noted that the above units, as a part of the apparatus, may run in the computer terminal provided in Example 1.

In the apparatus for accessing a private network of the example, a domain name resolution request from a client is obtained by a first obtaining unit. The domain name resolution request is determined to conform to a domain name format of the private network by a determining unit. A virtual address corresponding to the domain name format is allocated to the private network by an allocation unit. In response to a resource access request of the client, a target domain name of the private network is resolved from the virtual address through a resolution unit. Based on an original domain name of the private network corresponding to the target domain name, a network resource in the private network is accessed through an access unit. This achieves the technical effect of improving the network connectivity efficiency, and solves the technical problem of low network connectivity efficiency.

### Example 5

An example of the present disclosure may provide a processor, where the processor may include a computer terminal, and the computer terminal may be any computer terminal device in a computer terminal group. In an implementation, in this example, the computer terminal may be replaced by a terminal device such as a mobile terminal.

In this example, the computer terminal may be located in at least one of a plurality of network devices of a computer network.

In this example, the computer terminal may execute program codes of the following steps of the method for accessing a private network of an application: obtaining a domain name resolution request from a client, where the client is an accessing end to access the private network; determining that the domain name resolution request conforms to a domain name format of the private network; allocating a virtual address corresponding to the domain name format to the private network; resolving a target domain name of the private network from the virtual address in response to a resource access request from the client, where the resource access request conforms to the domain name format, and the target domain name is used to characterize a target address of the private network; and accessing a network resource in the private network based on an original domain name of the private network corresponding to the target domain name, where the domain name format is used for encoding the original domain name into the target domain name, and the original domain name is used for characterizing an original address of the private network.

In an example, FIG. 14 is a structural block diagram illustrating a computer terminal according to an example of the present disclosure. As shown in FIG. 14, the compute terminal A may include one or more processors 1402 (only one is shown), a storage 1404, and a transmission apparatus 1406.

The storage may be configured to store software programs and modules, such as instructions/modules corresponding to the private network access method and private network access apparatus in the examples of the present disclosure. The processor performs various functional applications and predictions by running the software programs and modules stored in the storage, i.e., perform the aforementioned private network access method. The storage may include high-speed random access memory and may also include non-volatile memory such as one or more magnetic storage devices, flash memory, or other non-volatile solid state memory. In some examples, the storage may further include storages located remotely from the processor, which may be connected to the computer terminal A through a network. Examples of the above network include, but are not limited to, the Internet, an intranet, a local area network, a mobile communication network, and combinations thereof.

The processor may call information and the applications stored in the storage through the transmission apparatus to perform the following steps of: obtaining a domain name resolution request from a client, where the client is an accessing end to access the private network; determining that the domain name resolution request conforms to a domain name format of the private network; allocating a virtual address corresponding to the domain name format to the private network; resolving a target domain name of the private network from the virtual address in response to a resource access request from the client, where the resource access request conforms to the domain name format, and the target domain name is used for characterizing a target address of the private network; and accessing a network resource in the private network based on an original domain name of the private network corresponding to the target domain name, where the domain name format is used for encoding the original domain name into the target domain name, and the original domain name is used for characterizing an original address of the private network.

In an example, the processor may further execute program codes of the following steps: determining a domain name field of the original domain name and a resource field of the network resource; establishing the domain name format based on the domain name field and the resource field.

In an example, the processor may further execute program codes of the following steps: extracting an attribute field of the network resource from the resource field, where the attribute field is used for characterizing a name and/or type of the network resource; and concatenating the attribute field to an end of the domain name field to obtain the domain name format.

In an example, the processor may further execute program codes of the following steps: detecting whether the domain name resolution request includes the original domain name, and a name and/or a type of the network resource; if it is detected that the domain name resolution request includes the original domain name, and the name of the network resource and/or the type of the network resource, determining that the domain name resolution request conforms to the domain name format, where the name of the network resource and/or the type of network resource are located at an end of the original domain name.

In an example, the processor may further execute program codes of the following steps: determining a first network segment where the client is currently located; determining a second network segment different from the first network segment; and allocating the virtual address corresponding to the domain name format and located on the second network segment to the private network.

In an example, the processor may further execute program codes of the following steps: in response to that the resource access request is transmitted according to a hypertext transfer protocol, sanitizing the resource access request, where the sanitized resource access request conforms to an original domain name format of the private network; based on the sanitized resource access request, resolving the original domain name corresponding to the target domain name from the virtual address.

In an example, the processor may further execute program codes of the following steps: resolving an identifier corresponding to the original domain name from a socket of the private network; and resolving the original domain name from the virtual address based on the identifier.

In an example, the processor may further execute program codes of the step of: accessing the private network based on a virtual extensible local area network, and accessing the network resource in the private network according to the original domain name.

In an example, the processor may further execute program codes of the following steps: obtaining a domain name resolution request from a service container of the client in a network proxy container, where the network proxy container and the service container share a same operating cycle, and the client accesses the private network through the service container; resolving the target domain name from the virtual address in response to a resource access request from the service container of the client.

In an example, the processor may call the information and the application stored in the storage through the transmission apparatus to execute the following steps: obtaining an original domain name of the private network, where the original domain name is used for characterizing an original address of the private network; encoding the original domain name according to a domain name format of the private network to obtain a target domain name of the private network, where the target domain name is used for characterizing a target address of the private network; issuing the target domain name to a client, so that the client sends, based on the target domain name, a domain name resolution request conforming to the domain name format and a resource access request conforming to the domain name format, where the domain name resolution request is used for allocating a virtual address corresponding to the domain name format to the private network, the resource access request is used for resolving the target domain of the private from the virtual address, and the original domain name corresponding to the target domain name is used to access a network resource in the private network.

In an example, the processor may call information and appplications stored in the storage through the transmission apparatus to execute the following steps of: obtaining an original domain name of the private network by invoking a first interface, where the first interface includes a first parameter, a parameter value of the first parameter is the original domain name, and the original domain name is used for characterizing an original address of the private network; encoding the original domain name according to a domain name format of the private network to obtain a target domain name of the private network, where the target domain name is used for characterizing a target address of the private network; issuing the target domain name to a client by invoking a second interface, so that the client, based on the target domain name, sends a domain name resolution request conforming to the domain name format and a resource access request conforming to the domain name format, where the second interface includes a second parameter, a parameter value of the second parameter is the target domain name. The domain name resolution request is used for allocating a virtual address corresponding to the domain name format to the private network. The resource access request is used for resolving the target domain name of the private network from the virtual address. The original domain name corresponding to the target domain name is used for accessing a network resource in the private network.

In an example of the present disclosure, a domain name format conforming to a private network is determined based on a domain name resolution request of a client. A virtual address corresponding to the domain name format is determined based on the domain name format of the private network. A resource access request conforming to the domain name format sent by the client is obtained, and a target domain name of the private network is resolved from the virtual address based on the resource access request. Based on an original domain name of the private network corresponding to the target domain name, the network resources in the private network may be accessed. This achieves the technical effect of improving the network connectivity efficiency, and solves the technical problem of low network connectivity efficiency.

Those with ordinary skill in the art may understand that the structure shown in FIG. 14 is only for example, and the computer terminal A may also be a smart phone (such as a tablet computer, a palmtop computer, a mobile Internet device (MID), or a PDA, etc. FIG. 14 does not limit the structure of the computer terminal A. For example, the computer terminal A may further include more or fewer components (such as a network interface, a display apparatus, etc.) than those shown in FIG. 14, or have a different configuration than those shown in FIG. 14.

Those with ordinary skill in the art may understand that all or a part of the steps in the various methods of the above example may be performed by applications instructing hardware related to the terminal device, and the applications may be stored in a computer readable storage medium, and the storage medium may include a flash disk, a read-only memory (ROM), a random access memory (RAM), a magnetic disk or an optical disk, and the like.

### Example 6

An example of the present disclosure further provides a computer readable storage medium. In an example, the computer-readable storage medium may be configured to store program codes for performing the method for accessing a private network provided in the Example 1.

In an example, the computer-readable storage medium may be located in any one computer terminal of a computer terminal group in the computer network, or located in any one mobile terminal of a mobile terminal group.

In an example, the computer readable storage medium is configured to store program codes for performing the following steps: obtaining a domain name resolution request from a client, where the client is an accessing end to access the private network; determining that the domain name resolution request conforms to a domain name format of the private network; allocating a virtual address corresponding to the domain name format to the private network; resolving a target domain name of the private network from the virtual address in response to a resource access request from the client, where the resource access request conforms to the domain name format, and the target domain name is used for characterizing a target address of the private network; and accessing a network resource in the private network based on an original domain name of the private network corresponding to the target domain name, where the domain name format is used for encoding the original domain name into the target domain name, and the original domain name is used for characterizing an original address of the private network.

In an example, the computer readable storage medium may further execute program codes of the following steps: determining a domain name field of the original domain name and a resource field of the network resource; and establishing the domain name format based on the domain name field and the resource field.

In an example, the computer readable storage medium may further execute program codes of the following steps: extracting an attribute field of a network resource from the resource field, where the attribute field is used for representing a name and/or a type of the network resource; and concatenating the attribute field to an end of the domain name field to obtain the domain name format.

In an example, the computer readable storage medium may further execute program codes of the following steps: detecting whether the domain name resolution request includes the original domain name, and a name and/or a type of the network resource; if it is detected that the domain name resolution request includes the original domain name, and the name of the network resource and/or the type of the network resource, determining that the domain name resolution request conforms to the domain name format, where the name of the network resource and/or the type of network resource are located at an end of the original domain name.

In an example, the computer readable storage medium may further execute program codes of the following steps: determining a first network segment where the client is currently located; determining a second network segment different from the first network segment; and allocating a virtual address corresponding to the domain name format and located on the second network segment to the private network.

In an example, the computer readable storage medium may further execute program codes of the following steps: in response to that the resource access request is transmitted according to a hypertext transfer protocol, sanitizing the resource access request, where the sanitized resource access request conforms to an original domain name format of the private network; based on the sanitized resource access request, resolving the original domain name corresponding to the target domain name from the virtual address.

In an example, the computer readable storage medium may further execute program codes of the following steps: resolving an identifier corresponding to the original domain name from a socket of the private network; and resolving the original domain name from the virtual address based on the identifier.

In an example, the computer readable storage medium may further execute program codes of the steps of: accessing the private network based on a virtual extensible local area network and accessing the network resource in the private network according to the original domain name.

In an example, the computer readable storage medium may further execute program codes of the following steps: obtaining the domain name resolution request from a service container of the client in a network proxy container, where the network proxy container and the service container share a same operating cycle, and the client accesses the private network through the service container; resolving the target domain name from the virtual address in response to a resource access request from the service container of the client.

In an example, the computer-readable storage medium is configured to store program codes for performing the steps of: obtaining an original domain name of the private network, where the original domain name is used to characterize an original address of the private network; encoding the original domain name according to a domain name format of the private network to obtain a target domain name of the private network, where the target domain name is used for characterizing a target address of the private network; issuing the target domain name to a client, so that the client sends, based on the target domain name, a domain name resolution request conforming to the domain name format and a resource access request conforming to the domain name format, where the domain name resolution request is used for allocating a virtual address corresponding to the domain name format to the private network, the resource access request is used for resolving the target domain name of the private network from the virtual address, and the original domain name corresponding to the target domain name is used to access a network resource in the private network.

In an example, the computer readable storage medium is configured to store program codes for performing the following steps: obtaining an original domain name of the private network by invoking a first interface, where the first interface includes a first parameter, a parameter value of the first parameter is the original domain name, and the original domain name is used for characterizing an original address of the private network; encoding the original domain name according to a domain name format of the private network to obtain a target domain name of the private network, where the target domain name is used for characterizing a target address of the private network; issuing the target domain name to a client by invoking a second interface, so that the client, based on the target domain name, sends a domain name resolution request conforming to the domain name format and a resource access request conforming to the domain name format, where the second interface includes a second parameter, a parameter value of the second parameter is the target domain name. The domain name resolution request is used for allocating a virtual address corresponding to the domain name format to the private network. The resource access request is used for resolving the target domain name of the private network from the virtual address. The original domain name corresponding to the target domain name is used for accessing a network resource in the private network.

In the example of the present disclosure, a domain name resolution request from a client is obtained, where the client is an accessing end to access a private network. It is determined that the domain name resolution request conforms to a domain name format of the private network. A virtual address corresponding to the domain name format is allocated to the private network. A target domain name of the private network is resolved from the virtual address in response to a resource access request from the client, where the resource access request conforms to the domain name format, and the target domain name is used for characterizing a target address of the private network. The network resource in the private network is accessed based on an original domain name of the private network corresponding to the target domain name, where the domain name format is used for encoding the original domain name into the target domain name, and the original domain name is used for characterizing an original address of the private network. That is to say, in the example of the present disclosure, it is determined that a domain name format conforming to the private network is determined based on the domain name resolution request from the client. Based on the domain name format of the private network, a virtual address corresponding to the domain name format is determined. A resource access request conforming to the domain name format sent by the client is obtained. A target domain name of the private network is resolved from the virtual address based on the resource access request. Based on an original domain name of the private network corresponding to the target domain name, the network resource in the private network may be accessed, so that the technical effect of improving the network connectivity efficiency is realized, and the technical problem of low network connectivity efficiency is solved.

The serial numbers of the examples of the present disclosure are for description only, and do not represent advantages and disadvantages of the examples.

In the above examples of the present disclosure, the description of each example has its own emphasis, and for a part not described in detail in a certain example, reference can be made to the relevant description of other examples.

In the several examples provided in the present disclosure, it is to be understood that the disclosed technical solutions may be implemented in other ways. The apparatus examples described above are only illustrative, for example, the division of units is only a division of logical functions, and there may be other division manners in actual implementation, for example, a plurality of units or components may be combined or integrated into another system, or some features may be omitted or not implemented. In addition, the mutual coupling or direct coupling or communication connection shown or discussed may be an indirect coupling or communication connection through some interfaces, units or modules, which may be electrical or in other forms.

The units illustrated as separate elements may or may not be physically separate, and the elements shown as units may or may not be physical units, i.e., may be located in one place, or may be distributed across multiple network elements. Some or all of the units may be selected according to actual needs to achieve the purpose of the solution of this example.

In addition, each functional unit in each example of the present disclosure may be integrated into one processing unit, or each unit may physically exist separately, or two or more units may be integrated into one unit. The integrated unit can be realized in the form of hardware or software function unit.

The integrated unit may be stored in a computer-readable storage medium if it is realized in the form of a software functional unit and sold or used as a separate product. Based on such understanding, the essence of the technical solution of the present disclosure or the part that contributes to the related technology or all or part of the technical solution may be embodied in the form of a software product, which is stored in a storage medium. Include instructions to cause a computer device (which may be a personal computer, server, network device, etc.) To perform all or a portion of the steps of the methods described in the various examples of the present disclosure. The aforementioned storage media include various media capable of storing program codes, such as a U disk, a read-only memory (ROM, Read-Only Memory), a random access memory (RAM, Random Access Memory), a portable hard disk, a magnetic disk, or an optical disk.

The above is only a preferred example of the present disclosure. It should be noted that, for those of ordinary skill in the art, a number of improvements and modifications can be made without departing from the principles of the present disclosure, and these improvements and modifications should also be considered as the scope of protection of the present invention.

1. A method for accessing a private network, comprising:
obtaining a domain name resolution request from a client, wherein the client is an accessing end to access the private network;
determining that the domain name resolution request conforms to a domain name format of the private network;
allocating a virtual address corresponding to the domain name format to the private network;
resolving a target domain name of the private network from the virtual address in response to a resource access request from the client, wherein the resource access request conforms to the domain name format, and the target domain name is used to characterize a target address of the private network; and
accessing a network resource in the private network based on an original domain name of the private network corresponding to the target domain name, wherein the domain name format is used for encoding the original domain name into the target domain name, and the original domain name is used for characterizing an original address of the private network.

2. The method according to claim 1, wherein the method further comprises:
determining a domain name field of the original domain name and a resource field of the network resource;
establishing the domain name format based on the domain name field and the resource field.

3. The method according to claim 2, wherein establishing the domain name format based on the domain name field and the resource field comprises:
extracting an attribute field of the network resource from the resource field, wherein the attribute field is used for representing a name and/or a type of the network resource; and
obtaining the domain name format by concatenating the attribute field to an end of the domain name field.

4. The method according to claim 1, wherein the method further comprises:
detecting whether the domain name resolution request comprises the original domain name, and a name and/or a type of the network resource;
if it is detected that the domain name resolution request comprises the original domain name, and the name and/or the type of the network resource, determining that the domain name resolution request conforms to the domain name format, wherein the name and/or the type of the network resource are located at an end of the original domain name.

5. The method according to claim 1, wherein allocating the virtual address corresponding to the domain name format to the private network comprises:
determining a first network segment where the client is currently located;
determining a second network segment different from the first network segment;
allocating the virtual address corresponding to the domain name format and located on the second network segment to the private network.

6. The method according to claim 1, wherein the method further comprises:
in response to that the resource access request is transmitted according to a hypertext transfer protocol, sanitizing the resource access request, wherein the sanitized resource access request conforms to an original domain name format of the private network;
based on the sanitized resource access request, resolving the original domain name corresponding to the target domain name from the virtual address.

7. The method according to claim 6, wherein resolving the original domain name corresponding to the target domain name from the virtual address comprises:
resolving an identifier corresponding to the original domain name from a socket of the private network;
resolving the original domain name from the virtual address based on the identifier.

8. The method according to claim 1, wherein accessing the network resource in the private network based on the original domain name of the private network corresponding to the target domain name comprises:
accessing the private network based on a virtual extensible local area network, and accessing the network resource in the private network according to the original domain name.

9. The method according to claim 1, wherein obtaining the domain name resolution request from the client comprises:
obtaining the domain name resolution request from a service container of the client in a network proxy container, wherein the network proxy container and the service container share a same operating cycle, and the client accesses the private network through the service container;
resolving the target domain name of the private network from the virtual address in response to the resource access request from the client comprises: resolving the target domain name from the virtual address in response to the resource access request from the service container of the client.

10. A method for accessing a private network, comprising:
obtaining an original domain name of the private network, wherein the original domain name is used for characterizing an original address of the private network;
encoding the original domain name according to a domain name format of the private network to obtain a target domain name of the private network, wherein the target domain name is used for characterizing a target address of the private network;
issuing the target domain name to a client, so that the client sends, based on the target domain name, a domain name resolution request conforming to the domain name format, and a resource access request conforming to the domain name format, wherein the domain name resolution request is used for allocating a virtual address corresponding to the domain name format to the private network; the resource access request is used for resolving the target domain name of the private network from the virtual address, and the original domain name corresponding to the target domain name is used for accessing a network resource in the private network.

11. (canceled)

12. A system for accessing a private network, comprising a client, a network proxy container and a gateway, wherein
the client is configured to send a domain name resolution request to the network proxy container, wherein the client is an accessing end to access the gateway;
the network proxy container is configured to determine that the domain name resolution request conforms to a domain name format of the gateway; allocate a virtual address corresponding to the domain name format to the gateway; resolve a target domain name of the gateway from the virtual address in response to a resource access request from the client, wherein the resource access request conforms to the domain name format, and the target domain name is used for characterizing a target address of the private network; access a network resource in the gateway based on an original domain name of the gateway corresponding to the target domain name, wherein the domain name format is used for encoding the original domain name into the target domain name, and the original domain name is used for characterizing an original address of the private network; and
the gateway is configured to return the network resource to the network proxy container.

13. The system according to claim 12, wherein the network proxy container comprises:
a request interception component, configured to detect whether the domain name resolution request includes the original domain name, and a name and/or a type of the network resource; if it is detected that the domain name resolution request includes the original domain name, and the name and/or the type of the network resource, determine that the domain name resolution request conforms to the domain name format, wherein the name and/or the type of the network resource are located at an end of the original domain name in the domain name resolution request.

14. The system according to claim 12, wherein the network proxy container comprises:
a transmission component, configured to determine a first network segment where the client is currently located; determine a second network segment different from the first network segment;
allocate the virtual address corresponding to the domain name format and located on the second network segment to the private network;
a sanitizing component, configured to sanitize the resource access request in response to that the resource access request is transmitted according to a hypertext transfer protocol, wherein the sanitized resource access request conforms to an original domain name format of the private network;
wherein the transmission component is further configured to resolve the original domain name corresponding to the target domain name from the virtual address based on the sanitized resource access request.

15. A computer terminal comprising a processor and a non-transitory computer-readable storage medium, wherein the processor executes program codes stored in the non-transitory computer-readable storage medium to perform the method for accessing a private network according to claim 1.

16. A non-transitory computer-readable storage medium for storing program codes executed by a processor to perform the method for accessing a private network according to claim 1.

17. The method for accessing a private network according to claim 10, wherein
obtaining the original domain name of the private network further comprises:
obtaining the original domain name of the private network by invoking a first interface, wherein the first interface comprises a first parameter, a parameter value of the first parameter is the original domain name; and
issuing the target domain name to the client further comprises:
issuing the target domain name to the client by invoking a second interface, wherein the second interface comprises a second parameter, a parameter value of the second parameter is the target domain name.
